(19) United States
(12) Patent Application Publication
(10) Pub. No.: US 2026/0138443 A1
(43) Pub. Date: May 21, 2026

(54) TOUCH DISPLAY APPARATUS

(71) Applicant: CARUX TECHNOLOGY PTE. LTD., SINGAPORE (SG)

(72) Inventor: Tsan-Po Weng, Tainan (TW)

(73) Assignee: CARUX TECHNOLOGY PTE. LTD., SINGAPORE (SG)

(21) Appl. No.: 19/358,397

(22) Filed: Oct. 14, 2025

(30) Foreign Application Priority Data
Nov. 15, 2024 (CN) 202411637771.1

(51) Int. Cl. B60K 35/10; B60K 35/22; G06F 3/042; G06F 3/041

(52) U.S. Cl. CPC B60K 35/10; B60K 35/22; G06F 3/042; B60K 2360/1438; G06F 3/04184

(57) ABSTRACT

The disclosure provides a touch display apparatus. The touch display apparatus includes a substrate, a display unit, a touch unit, a display touch chip, and a system on a chip. The display unit is used to receive a display signal to display an image. The touch unit is used to sense a touch signal. The display touch chip is electrically connected to the display unit and the touch control unit. The system on a chip is electrically connected to the display touch chip. The system on a chip is used to provide a first digital signal to the display touch chip, and the display touch chip receives the touch signal to generate a second digital signal, and provides the second digital signal to the system on a chip for signal processing. The touch display apparatus in the disclosure may achieve good display and touch functions.

### CROSS-REFERENCE TO RELATED APPLICATION

This application claims the priority benefit of China application serial no. 202411637771.1, filed on November 15, 2024. The entirety of the above-mentioned patent application is hereby incorporated by reference herein and made a part of this specification.

### BACKGROUND

### TECHNICAL FIELD

The disclosure relates to an apparatus, and more particularly, to a touch display apparatus.

### DESCRIPTION OF RELATED ART

Generally speaking, in an application of a large-size vehicle display touch panel, due to the large size of the panel, signal distortion is prone to occur during transmission of a display driving signal and a touch sensing signal, which may easily lead to poor functionality and poor user experience.

### SUMMARY

The disclosure is directed to a touch display apparatus that may provide both touch and display functions.

According to an embodiment of the disclosure, a touch display apparatus in the disclosure includes a substrate, a display unit, a touch unit, a display touch chip, and a system on a chip. The substrate includes an active region and a peripheral region. The display unit is disposed on the active region, and is used to receive a display signal, so as to display an image. The touch unit is disposed on the active region, and is used to sense a touch signal. The display touch chip is bonded to the peripheral region, and is electrically connected to the display unit and the touch unit. The system on a chip is electrically connected to the display touch chip. The system on a chip is used to provide a first digital signal to the display touch chip, so that the display touch chip generates the display signal, and the display touch chip receives the touch signal to generate a second digital signal, and provides the second digital signal to the system on a chip for signal processing.

### BRIEF DESCRIPTION OF THE DRAWINGS

FIG. 1 is a schematic view of a touch display apparatus according to an embodiment of the disclosure.

FIG. 2 is a schematic view of a touch display apparatus according to an embodiment of the disclosure.

FIG. 3 is a schematic view of a touch display apparatus according to an embodiment of the disclosure.

FIG. 4 is a schematic view of a touch display apparatus according to an embodiment of the disclosure.

FIG. 5 is a schematic view of a display touch chip and a system on a chip according to an embodiment of the disclosure.

FIG. 6 is a schematic view of a system on a chip and a display touch chip according to an embodiment of the disclosure.

FIG. 7 is a schematic view of a system on a chip and a display touch chip according to an embodiment of the disclosure.

FIG. 8 is a flow chart of an operating method of a touch display apparatus according to an embodiment of the disclosure.

FIG. 9 is a flow chart of an operating method of a touch display apparatus according to an embodiment of the disclosure.

### DETAILED DESCRIPTION OF DISCLOSED EMBODIMENTS

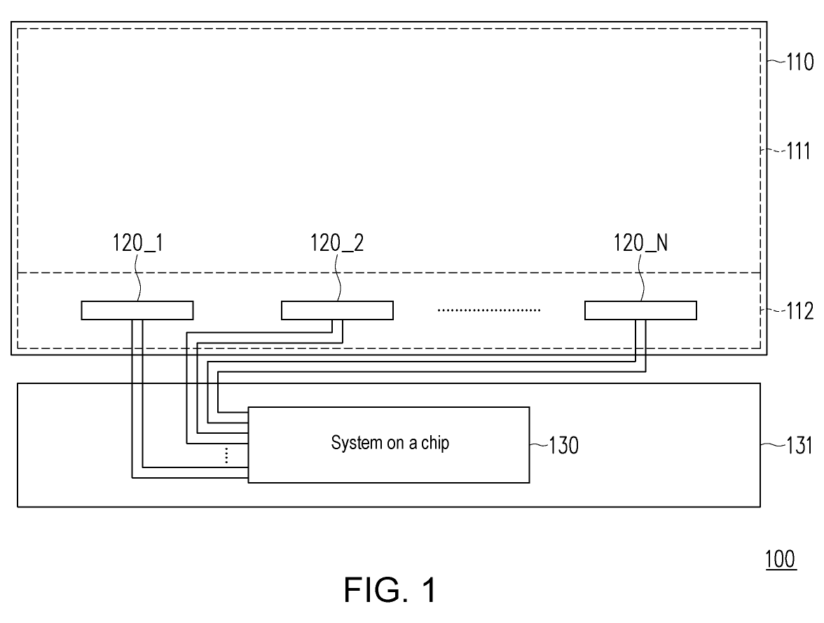

FIG. 1 is a schematic view of a touch display apparatus according to an embodiment of the disclosure. Referring to FIG. 1, a touch display apparatus 100 includes a substrate 110 (i.e., a display touch panel), display touch chips 120_1 to 120_N, and a system on a chip (SoC) 130, where N is a positive integer. In this embodiment, the substrate 110 includes an active region 111 and a peripheral region 112. The touch display apparatus 100 further includes multiple display units and multiple touch units. The display units are disposed on the active region 111, and are used to receive a display signal, so as to display an image. The touch units are disposed on the active region 111, and are used to sense a touch signal. The display touch chips 120_1 to 120_N are bonded to the peripheral region 112, and are electrically connected to the display units and the touch units. The system on a chip 130 is electrically connected to the display touch chips 120_1 to 120_N. The system on a chip 130 is used to provide multiple first digital signals to the display touch chips 120_1 to 120_N, so that the display touch chips 120_1 to 120_N generate the display signal to the display units, and the display touch chips 120_1 to 120_N receive the touch signal from at least one of the touch units to generate at least one second digital signal, and provide the second digital signal to the system on a chip 130 for signal processing.

In this embodiment, the display touch chips 120_1 to 120_N may be analog chips or mixed signal chips, and may include a display driving module and a touch sensing module respectively. The display touch chips 120_1 to 120_N may be used to provide the display signal and receive the touch signal respectively to achieve display driving and touch sensing functions. In this embodiment, the substrate 110 may be a large-area vehicle display panel, and may be implemented using a chip on glass (COG) process technology. In this embodiment, the system on a chip 130 may be disposed on another substrate 131. The system on a chip 130 may be a full digital chip, and may include a timing controller (TCON) and a microcontroller (MCU) and may have a modulation point to point interface (MPI). In this embodiment, the first digital signal may be a modulated display differential signal, and the second digital signal may also be a modulated touch differential signal. Therefore, the touch display apparatus 100 in this embodiment may achieve good signal quality and signal transmission bandwidth through a point-to-point differential signal design.

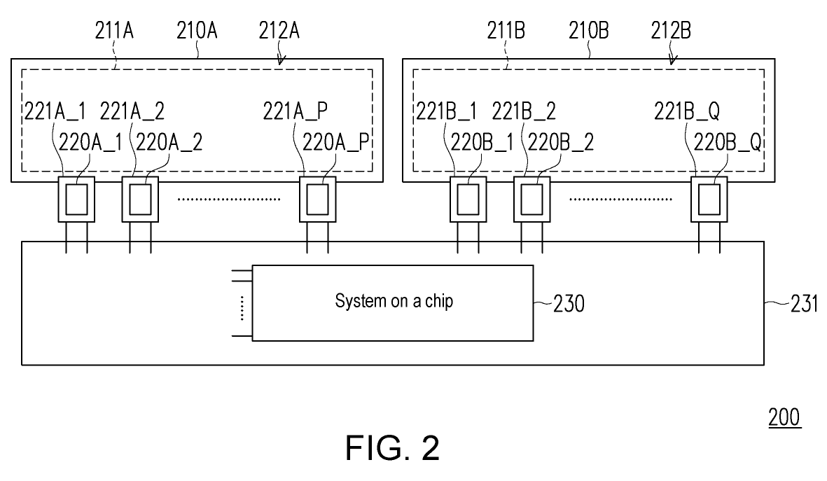

FIG. 2 is a schematic view of a touch display apparatus according to an embodiment of the disclosure. Referring to FIG. 2, a touch display apparatus 200 includes substrates 210A and 210B, display touch chips 220A_1 to 220A_P and 220B_1 to 220B_Q, and a system on a chip 230, wherein P and Q are positive integers respectively. In this embodiment., the substrate 210A includes an active region 211A and a peripheral region 212A. The substrate 210B includes an active region 211B and a peripheral region 212B. The touch display apparatus 200 further includes multiple display units and multiple touch units. The display units are respectively disposed on the active regions 211A and 211B, and are used to receive the display signal to display the image. The touch units are disposed on the active regions 211A and 211B, and are used to sense the touch signal. The display touch chips 220A_1 to 220A_P and 220B_1 to 220B_Q are respectively bonded to the peripheral regions 212A and 212B, and are electrically connected to the display units and the touch control units. The system on a chip 230 is electrically connected to the display touch chips 220A_1 to 220A_P and 220B_1 to 220B_Q. The system on a chip 230 is used to provide the first digital signals to the display control chips 220A_1 to 220A_P and 220B_1 to 220B_Q, so that the display touch chips 220A_1 to 220A_P and 220B_1 to 220B_Q respectively generate the display signal to the display units, and the display touch chips 220A_1 to 220A_P and 220B_1 to 220B_Q receive the touch signal from at least one of the touch control units to generate the at least one second digital signal, and provide the second digital signal to the system on a chip 230 for the signal processing.

In this embodiment, the display touch chips 220A_1 to 220A_P and 220B_1 to 220B_Q may be analog chips or mixed signal chips respectively, and may include the display driving module and the touch sensing module respectively. The display touch chips 220A_1 to 220A_P may be respectively disposed on substrates 221A_1 to 221A_P first, and then respectively bonded to the peripheral regions 212A. The display touch chips 220B_1 to 220B_Q may be respectively disposed on substrates 221B_1 to 221B_Q first, and then respectively bonded to the peripheral region 212B. In this embodiment, the display touch chips 220A_1 to 220A_P and 220B_1 to 220B_Q may be used to provide the display signal and receive the touch signal respectively, so as to achieve the display driving and touch sensing functions. In this embodiment, the touch display apparatus 200 may realize a multi-screen vehicle display through the substrates 210A and 210B, and may be implemented using the chip on glass process technology. In this embodiment, the system on a chip 230 may be disposed on another substrate 231. The system single chip 230 may include the timing controller and the microcontroller, and may have the modulation point to point interface. In this embodiment, the first digital signal may be the modulated display differential signal, and the second digital signal may also be the modulated touch differential signal. Therefore, the touch display apparatus 200 in this embodiment may achieve good signal quality and signal transmission bandwidth through the point-to-point differential signal design.

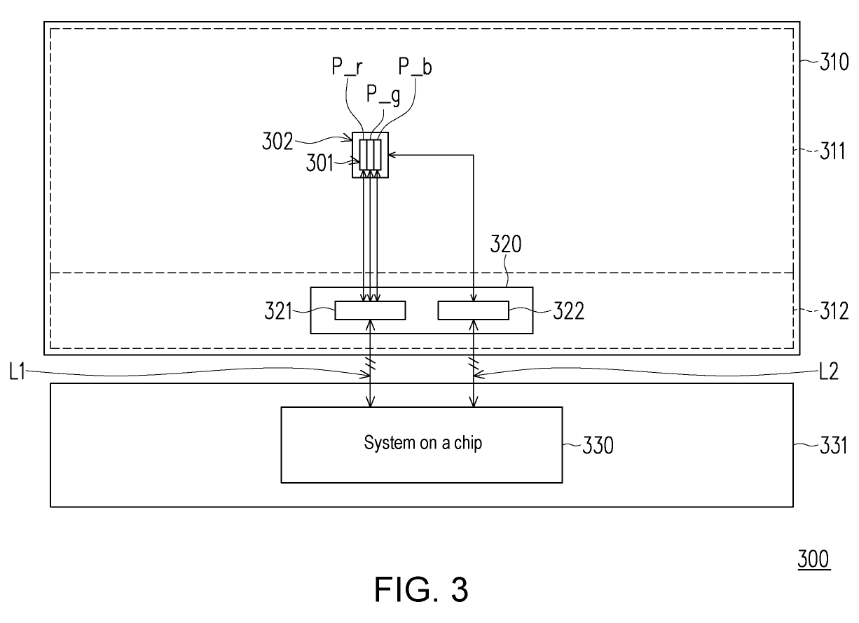

FIG. 3 is a schematic view of a touch display apparatus according to an embodiment of the disclosure. In this embodiment, the touch display apparatus 300 includes a substrate 310, a display touch chip 320, and a system on a chip 330. In this embodiment, the substrate 310 includes an active region 311 and a peripheral region 312. The touch display apparatus 300 further includes a display unit 301 and a touch unit 302. The display unit 301 may include a red sub-pixel P_r, a green sub-pixel P_g, and a blue sub-pixel P_b. The display unit 301 may be disposed on the active region 311 and used to receive the display signal to display the image. The touch unit 302 may be disposed on the active region 311 and used to sense the touch signal. The touch unit 302 may be a transparent electrode, and is disposed on the display unit 301.

In this embodiment, the display touch chip 320 is bonded to the peripheral region 312. The display touch chip 320 includes a display driving module 321 and a touch sensing module 322. The display touch chip 320 is electrically connected to the display unit 301 and the touch unit 302. The system on a chip 330 may be electrically connected to the display touch chip 320 through a pair of display connecting lines L1 and a pair of touch connecting lines L2. The system on a chip 330 is used to provide the display differential signal to the display touch chip 320 through the pair of display connecting lines L1, so that the display touch chip 320 generates the display signal to the display unit 301, and the display touch chip 320 receives the touch signal from the touch unit 302 through the pair of touch connecting lines L2 to generate the touch differential signal, and provides the touch differential signal to the system on a chip 330 for the signal processing.

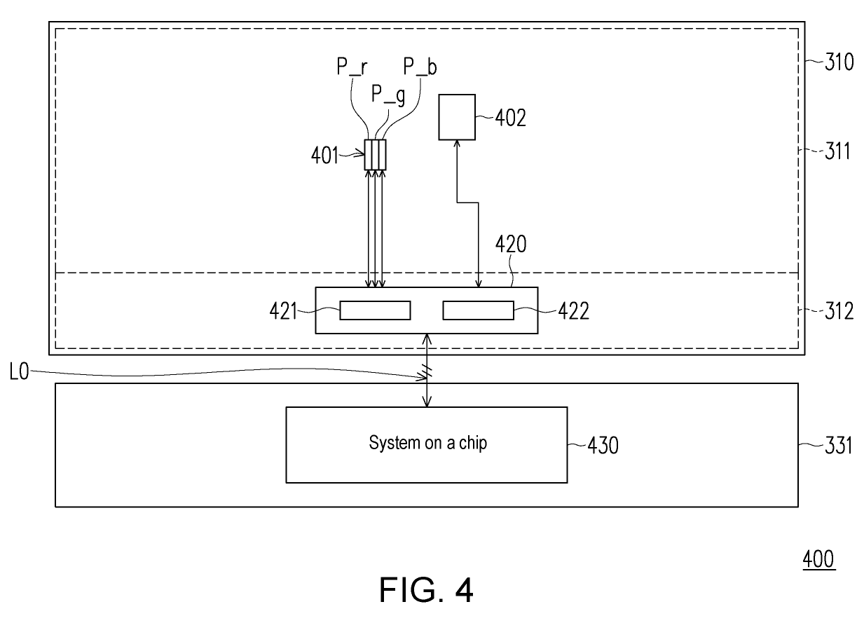

FIG. 4 is a schematic view of a touch display apparatus according to an embodiment of the disclosure. The touch display apparatus 400 further includes a display unit 401 and a touch unit 402. The display unit 401 may be disposed on the active region 311 and used to receive the display signal to display the image. The touch unit 402 may be disposed on the active region 311 and used to sense the touch signal. In addition, the touch unit 402 may be an optical touch unit.

In this embodiment, the display touch chip 420 is bonded to the peripheral region 312. The display touch chip 420 includes a display driving module 421 and a touch sensing module 422. The system on a chip 430 may be electrically connected to the display touch chip 420 through a pair of display touch connecting lines L0. The system on a chip 430 is used to provide the display differential signal to the display touch chip 420 through the pair of display touch connecting lines L0, so that the display touch chip 420 generates the display signal to the display unit 401, and the display touch chip 420 receives the touch signal from the touch unit 402 through the same pair of display touch connecting lines L0 to generate the touch differential signal, and provides the touch differential signal to the system on a chip 430 for the signal processing.

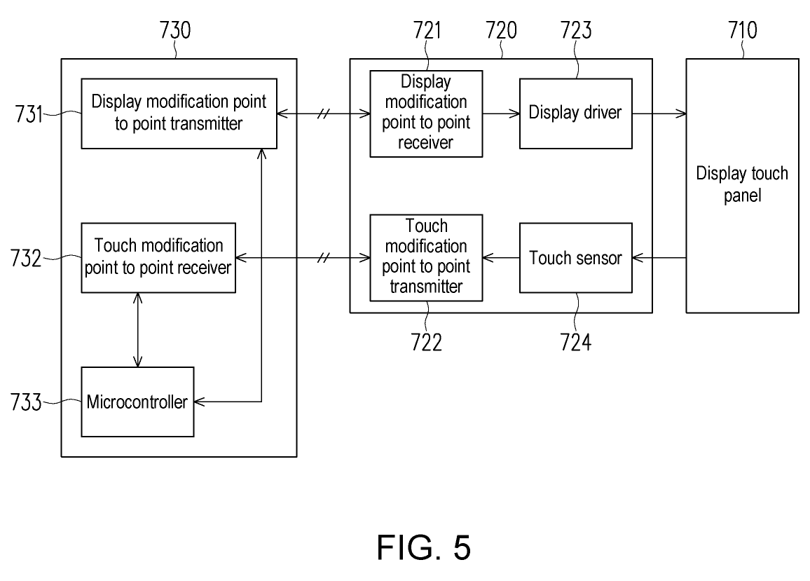

FIG. 5 is a schematic view of In this embodiment, a display touch chip 720 may be electrically connected to a display touch panel 710 and a system on a chip 730. The display touch chip 720 may include a display modification point to point receiver (DMPR) 721, a touch modification point to point transmitter (TMPT) 722, a display driver 723, and a touch sensor 724. The system on a chip 730 may include a display modification point to point transmitter 731, a touch modification point to point receiver 732, and a microcontroller 733. In this embodiment, the display driver 723 and the touch sensor 724 are electrically connected to the display touch panel 710. The display modification point to point receiver 721 is electrically connected to the display driver 723 and the display modification point to point transmitter 731. The touch modification point to point transmitter 722 is electrically connected to the touch sensor 724 and the touch modification point to point receiver 732. The microcontroller 733 is electrically connected to the display modification point to point transmitter 731 and the touch modification point to point receiver 732. In this embodiment, the display modification point to point receiver 721 may be electrically connected to the display modification point to point transmitter 731 through a pair of display connecting lines. The touch modification point to point transmitter 722 may be electrically connected to the touch modification point to point receiver 732 through a pair of touch connecting lines.

In this embodiment, the microcontroller 733 may control the display modification point to point transmitter 731 and the touch modification point to point receiver 732 to control the corresponding display touch chip 720 to perform display driving and touch sensing. In this embodiment, the display modification point to point transmitter 731 may encode the display driving data to be transmitted to the display modification point to point receiver 721. The display modification point to point receiver 721 may decode the received display driving data and provide the corresponding display driving data to the display driver 723, so that the display driver 723 may drive a display unit in the display touch panel 710 according to the display driving data. In this embodiment, the touch sensor 724 may receive the touch sensing data from a touch unit in the display touch panel 710 to be transmitted to the touch modification point to point transmitter 722. The touch modification point to point transmitter 722 may encode the touch sensing data to be transmitted to the touch modification point to point receiver 732. The touch modification point to point receiver 732 may decode the received touch sensing data to be provided to the microcontroller 733, so that the microcontroller 733 may determine a corresponding touch sensing result.

In some embodiment, the display touch chip 720 may further comprise a first switch (not illustrated). The system on a chip 730 may further comprise a second switch (not illustrated). The display modification point to point receiver 721 is electrically connected to the display driver 723 and the first switch. The first switch is electrically connected to the second switch. The second switch is electrically connected to the display modification point to point transmitter 731. The touch modification point to point transmitter 722 is electrically connected to the touch sensor 724 and the first switch. The second switch is electrically connected to the touch modification point to point receiver 732. In this embodiment, the first switch may be electrically connected to the second switch through a pair of display touch connecting lines, and the second switch may be electrically connected to the display modification point to point transmitter 731 through a pair of display connecting lines and electrically connected to the touch modification point to point receiver 732 through a pair of touch connecting lines.

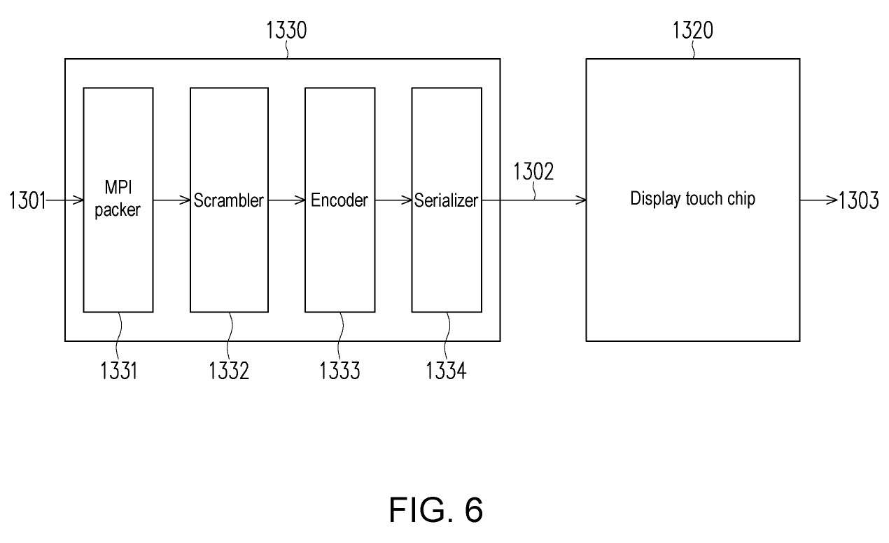

FIG. 6 is a schematic view of a system on a chip and a display touch chip according to an embodiment of the disclosure. FIG. 6 is a schematic view illustrating an architecture of forming the display driving data into the data packet in the system on a chip. Referring to FIG. 6, a system on a chip 1330 may include an MPI packer 1331, a scrambler 1332, an encoder 1333, and a serializer 1334. In this embodiment, the MPI packer 1331 may receive display data 1301 and package the display data 1301 to generate the data packet. The scrambler 1332 may add a randomized signal to the data packet to increase data security. The encoder 1333 may encode the data packet and serialize it through the serializer 1334 to form a display differential signal 1302 to be transmitted to a display touch chip 1320. The display touch chip 1320 may decode the display differential signal 1302 to generate a display (driving) signal 1303 for driving the display touch panel.

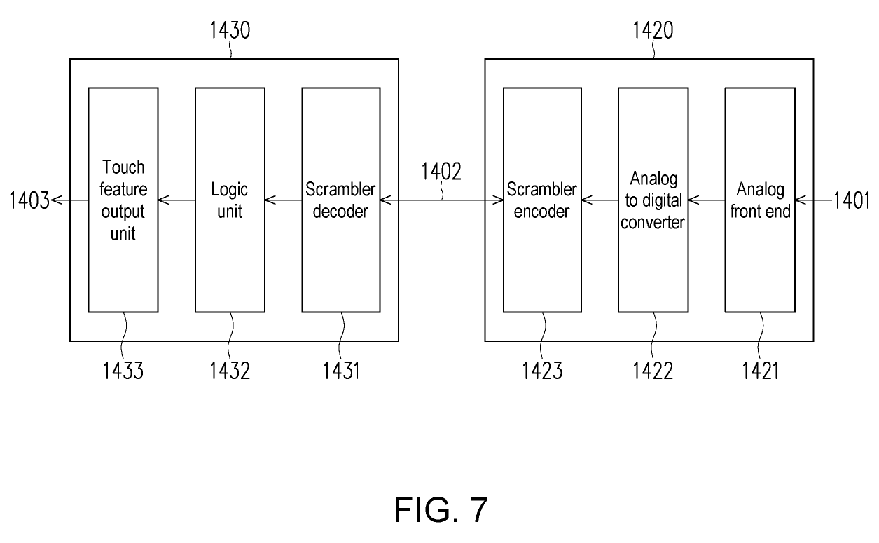

FIG. 7 is a schematic view of a system on a chip and a display touch chip according to an embodiment of the disclosure. FIG. 7 is a schematic view illustrating an architecture of forming the touch sensing data into the data packet in the system on a chip and the display touch chip. Referring to FIG. 7, a display touch chip 1420 may include an analog front end 1421, an analog to digital converter (ADC) 1422, and an encoder 1423. A system on a chip 1430 may include a scrambler decoder 1431, a logic unit 1432, and a touch feature output unit 1433. In this embodiment, the analog front end 1421 may receive a touch sensing signal 1401 from the touch units of the display touch panel. The analog to digital converter 1422 may convert the touch sensing signal 1401 from analog to data in a digital form. The scrambler encoder 1423 may add the randomized signal to a data packet of the digital touch sensing signal 1401 to increase data security, and form a touch differential signal 1402 to be transmitted to the scrambler decoder 1431. The scrambler decoder 1431 may decode the touch differential signal 1402, and then the logic unit 1432 performs a logic operation to provide touch feature data (e.g., coordinate data of a touch position on a panel) to the touch feature output unit 1433, so that the touch feature output unit 1433 may output the relevant touch feature data 1403 to a back-end functional unit for use.

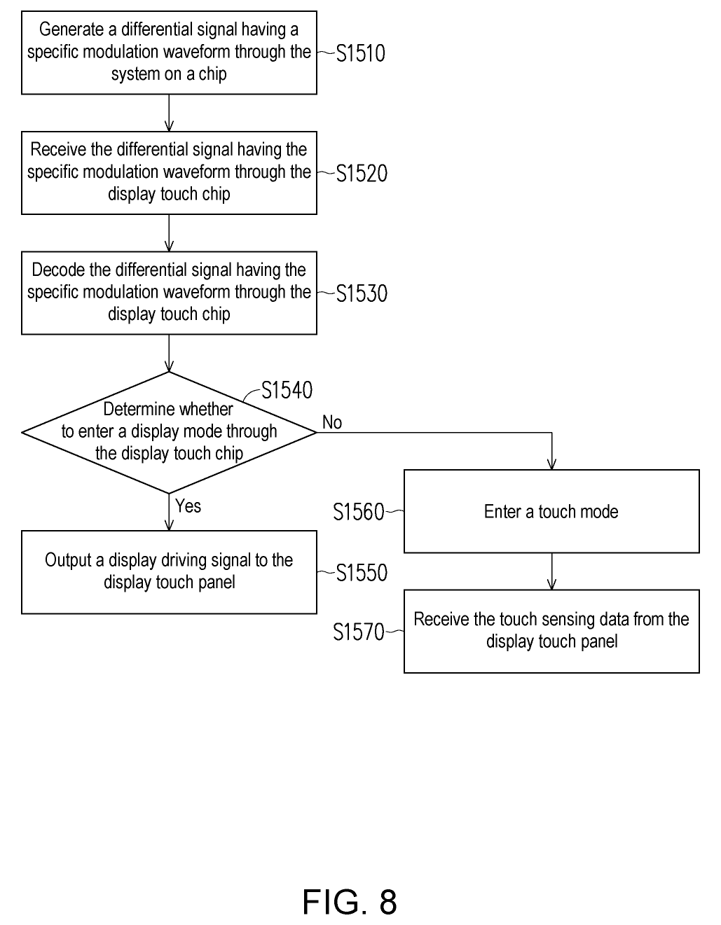

FIG. 8 is a flow chart of an operating method of a touch display apparatus according to an embodiment of the disclosure. Referring to FIG. 6 and FIG. 8, in step S1510, the system on a chip 1330 may generate a differential signal having a specific modulation waveform. In this embodiment, the system on a chip 1330 may package the display data 1301, add the randomized signal, and serialize the display data 1301 through the MPI packer 1331, the scrambler 1332, the encoder 1333, and the serializer 1334 to form the display differential signal 1302 having the specific modulation waveform. In step S1520, the display touch chip 1320 receives the differential signal 1302 having the specific modulation waveform. In step S1530, the display touch chip 1320 decodes the differential signal 1302 having the specific modulation waveform. In step S1540, the display touch chip 1320 may determine whether to enter a display mode. In this embodiment, the display touch chip 1320 may determine whether the display (driving) signal 1303 is obtained after decoding. If yes, in step S1550, the display touch chip 1320 may output a display (driving) signal 1303 to the display touch panel. If not, in step S1560, the touch control chip 1320 may enter a touch mode. In this embodiment, the display touch chip 1320 may be switched to attempt to perform a touch sensing operation. In step S1570, the display touch chip 1320 may receive the touch sensing data from the display touch panel. Therefore, the operating method in this embodiment may enable the touch display apparatus to achieve an effective display driving function.

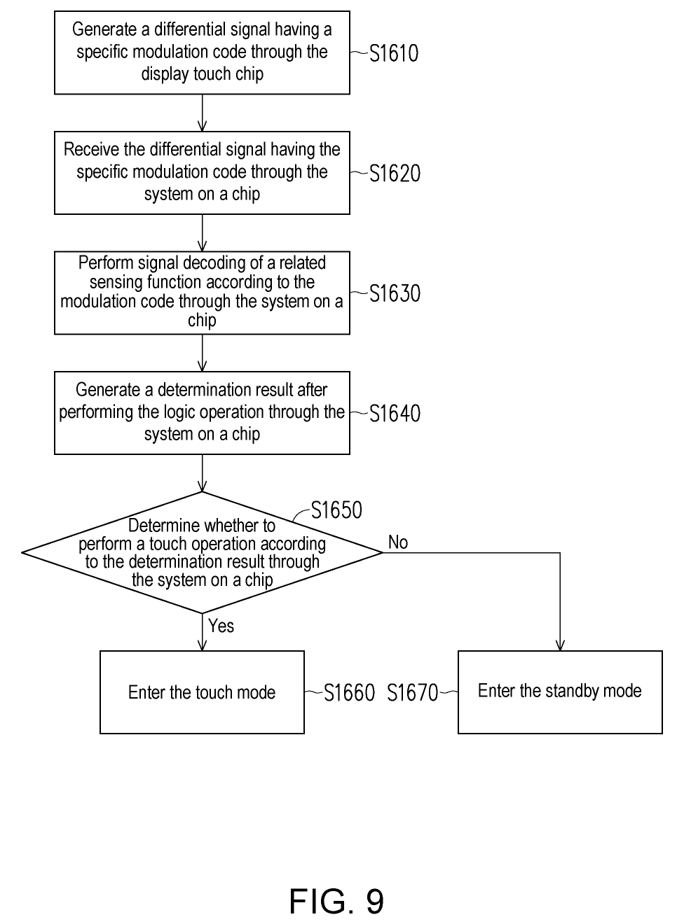

FIG. 9 is a flow chart of an operating method of a touch display apparatus according to an embodiment of the disclosure. Referring to FIG. 7 and FIG. 9, in step S1610, the display touch chip 1420 generates a differential signal having a specific modulation code. In this embodiment, the display touch chip 1420 may receive the touch sensing signal 1401 provided by the touch units of the touch display panel through the analog front end 1421, and perform signal conversion and encoding through the analog to digital converter 1422 and the scrambler encoder 1423 to generate the touch differential signal 1402.

In step S1620, the system on a chip 1430 receives the differential signal having the specific modulation code. In step S1630, the system on a chip 1430 performs signal decoding of a related sensing function according to the modulation code. In this embodiment, the system on a chip 1430 may perform the signal decoding on the touch differential signal 1402 through the scrambler decoder 1431. In step S1640, the system on a chip 1430 generates a determination result after performing the logic operation. In this embodiment, the system on a chip 1430 may perform the logic operation on the decoded data through the logic unit 1432 to generate the determination result (i.e., generating the touch feature data). In step S1650, the system on a chip determines whether to perform a touch operation according to the determination result. In this embodiment, the system on a chip 1430 may determine whether to generate the touch feature data through the touch feature output unit 1433. If yes, in step S1660, the system on a chip 1430 may enter the touch mode and output the relevant touch feature data 1403 to the back-end functional unit for use. If not, in step S1670, the system on a chip 1430 may enter a standby mode and may execute step S1610 again to continue determining whether a touch event occurs. Therefore, the operating method in this embodiment may enable the touch display apparatus to achieve an effective touch sensing function.

Based on the above, the touch display apparatus in the disclosure may transmit the display driving signal and the touch sensing signal for the display touch panel through a signal transmission method of the differential signal, so as to effectively reduce an issue of signal distortion in an application of a large-size panel. The touch display apparatus in the disclosure may further realize display driving and touch sensing under a multi-screen architecture. The touch display apparatus in the disclosure may further realize a function of performing the DC or AC charging on functional units in the display touch panel.

What is claimed is:

1. A touch display apparatus, comprising:
a substrate comprising an active region and a peripheral region;
a display unit disposed on the active region and used to receive a display signal to display an image;
a touch unit disposed on the active region and used to sense a touch signal;
a display touch chip bonded to the peripheral region and electrically connected to the display unit and the touch unit; and
a system on a chip electrically connected to the display touch chip,
wherein the system on a chip is used to provide a first digital signal to the display touch chip, so that the display touch chip generates the display signal, and the display touch chip receives the touch signal to generate a second digital signal, and provides the second digital signal to the system on a chip for signal processing.

2. The touch display apparatus according to claim 1, wherein the system on a chip comprises a timing controller and a microcontroller.

3. The touch display apparatus according to claim 1, wherein the display touch chip comprises a display driving module and a touch sensing module.

4. The touch display apparatus according to claim 1, wherein the system on a chip is disposed on another substrate.

5. The touch display apparatus according to claim 1, wherein the system on a chip is electrically connected to the display touch chip through a pair of display connecting lines and a pair of touch connecting lines.

6. The touch display apparatus according to claim 1, wherein the system on a chip is electrically connected to the display touch chip through a pair of display touch connecting lines.

7. The touch display apparatus according to claim 1, wherein the first digital signal is a display differential signal.

8. The touch display apparatus according to claim 1, wherein the second digital signal is a touch differential signal.

9. The touch display apparatus according to claim 1, wherein the touch unit is disposed on the display unit.

10. The touch display apparatus according to claim 1, wherein the display unit and the touch unit are disposed on a same layer of the substrate.

11. The touch display apparatus according to claim 1, wherein the substrate is a vehicle display panel.

12. The touch display apparatus according to claim 1, wherein the substrate is a glass substrate.

13. The touch display apparatus according to claim 1, wherein the system on a chip has a modulation point to point interface.

14. The touch display apparatus according to claim 1, wherein the touch unit is a transparent electrode.

15. The touch display apparatus according to claim 1, wherein the touch unit and a trace or an electrode of a common voltage on the substrate are disposed in a same layer.

16. The touch display apparatus according to claim 1, wherein the touch unit is an optical touch unit.

17. The touch display apparatus according to claim 1, wherein data formats of the first digital signal and the second digital signal respectively comprise a pre-sensing block, a blanking block, and a data stream block, and a charging block.

18. The touch display apparatus according to claim 1, wherein the system on a chip charges a display touch panel through the first digital signal and the second digital signal.

19. The touch display apparatus according to claim 1, wherein the first digital signal and the second digital signal form a display touch differential signal.
